(19) United States
(12) Patent Application Publication
(10) Pub. No.: US 2020/0331650 A1
(43) Pub. Date: Oct. 22, 2020

(54) CONCAVE OR ORIFICE FOOTHOLDS FOR BUCKETS, TROUGHS, TUBS,CONTAINERS, RECEPTACLES, AND BINS

(71) Applicant: Valerie Chandra Hetzel, Amherst, MA (US)

(72) Inventor: Valerie Chandra Hetzel, Amherst, MA (US)

(73) Assignee: Valerie Chandra Hetzel

(21) Appl. No.: 16/390,304

(22) Filed: Apr. 22, 2019

(51) Int. Cl. B65D 1/14; B65F 1/14

(52) U.S. Cl. CPC B65D 1/14; B65F 1/1452

(57) ABSTRACT

A portable container, tub, trough, bucket, or bin, comprised of metal, plastic, fiberglass, glass, cardboard, plant composite or wood or composite therein that contains concave or orifice foothold/s within the plane of its walls and located above and molded to container floor or below it's floor, respectively.

### CROSS-REFERENCE TO RELATED APPLICATIONS

U.S. Pat. No. 7,438,199, U.S. Pat. No. 9,682,818, U.S. Pat. No. 8,955,710, U.S. Pat. No. 8,844751

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Background of Invention

This invention is a general new use of old technology. It was borne out of the lack of such a product in the market. The need for containers to contain footholds while still being able to be stacked is the result of inventor having mishaps with several versions of containers that do not contain footholds.

### (1) Field of the Invention

Portable Containers

### (2) Description of Related Art

Application Ser. No. 16/385,995 (abandoned)

### BRIEF SUMMARY OF THE INVENTION

Summary of Invention

Footholds within the plane of a portable container to aid in the operation of tumble free insertion or removal of contents, or beings from said container. Such container allows for user/s foot/feet to stabilize such a container freeing hands to complete the insertion or removal of contents, or beings. If a container has one or more footholds, the user or users can manipulate the contents with two hands while steading the container.

Portable container includes bins, buckets, receptacles, cans, tubs, and troughs. The invention was bore out of the difficulty of,

A. Removing a tight fitting lid from a container safely without spillage.

B. Placing items in to a container, which are bulky needing to steady the container at the same time.

C. Removing vacuum suctioned or overstuffed trash bags from a trashcan.

D. Removing a pet, farm animal or baby from a portable bath without splashing or tipping the tub.

E. Removing moving animals such as chicks while steadying container with foot.

F. Having only one usable hand in which to remove a lid or items in a container without tipping the container.

The reason to apply footholds on so many containers is the lack of such products in the marketplace. The utility of these footholds regardless of shape of portable container, round, square, etc. is to provide a more secure and efficient way of completing tasks. Few trash containers have such a device, and most others don't exist in the market today. The use improves the safety in operation, by reducing container tipping during operation, and reduces likelihood spillage.

### BRIEF DESCRIPTION OF THE SEVERAL VIEWS OF THE DRAWING(S)

### Detailed Description of Invention

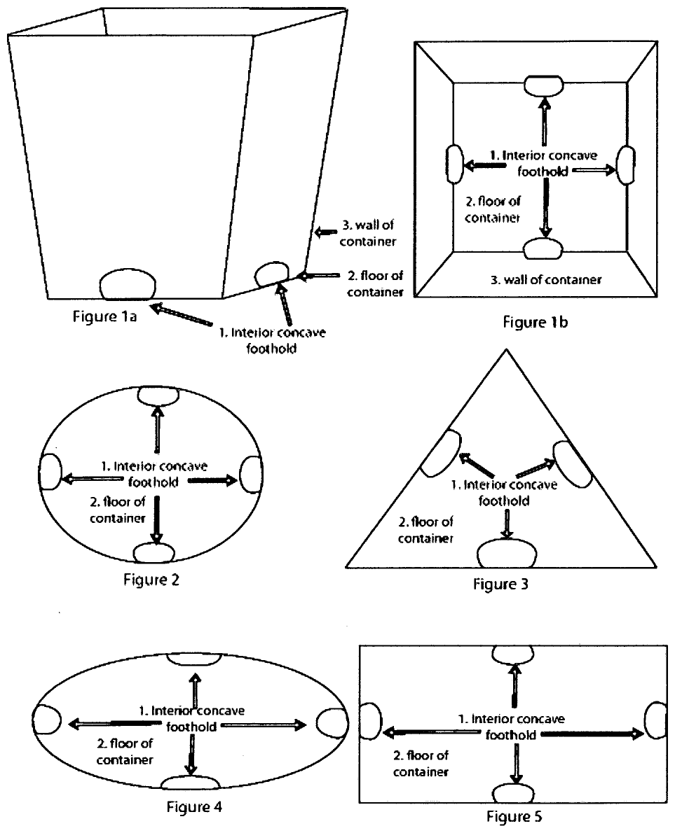

FIG. 1a Page 1 Replacement Drawing Is a sample of a portable container that is sloped with no base, as seen from the side. The footholds are not extruded beyond the walls of the container and are at least large enough for an average adult size toes in shoes to fit inside comfortably. The location is directly above the floor, whereby when utilized weight of individual can be transferred to the container.

FIG. 1b Page 1 Replacement Drawing Is the top view of FIG. 1a.

FIG. 2 Page 1 Replacement Drawing Is atop view of an example of another shape of portable container, in this case, a non-sloped container without a base, representing a non-sloped cylinder container.

FIG. 3 Page 1 Replacement Drawing Is a top view of an example of another shape of portable container, in this case, a non-sloped triangular container.

FIG. 4 Page 1 Replacement Drawing Is a top view of an example of another shape of portable container, in this case, a non-sloped oblong circular container.

FIG. 5 Page 1 Replacement Drawing Is a top view of an example of another shape of portable container, in this case, a non-sloped rectangular container.

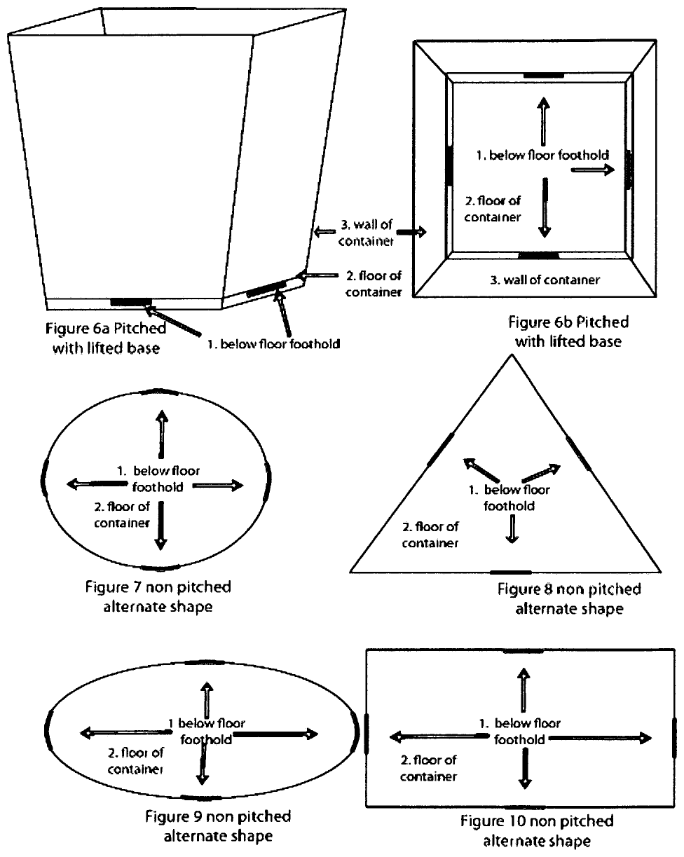

FIG. 6a Page 2 Replacement Drawing Is a side view of a sloped portable container with a base, representing a sloped square container. The footholds are orifices within the wall and below the floor in the base of the container and are at least large enough for an average adult size toes in shoes to fit inside comfortably. The location is directly below the floor, whereby when utilized weight of individual can be transferred to the container.

FIG. 6b Page 2 Replacement Drawing Is a top view of FIG. 6a.

FIG. 7 Page 2 Replacement Drawing Is a top view of an example of another shape of portable container, in this case, a non-sloped cylinder container.

FIG. 8 Page 2 Replacement Drawing Is a top view of an example of another shape of portable container, in this case, a non-sloped triangular container.

FIG. 9 Page 2 Replacement Drawing Is a top view of an example of another shape of portable container, in this case, a non-sloped oblong circular container.

FIG. 10 Page 2 Replacement Drawing Is a top view of an example of another shape of portable container, in this case, a non-sloped rectangular container.

This is global use of footholds is to aid in removal or pouring of contents into a portable container, by preventing the container from moving, during the operation. Originally considered to aid an individual in his or her task, several persons needing to be hands free would also benefit from oppositely placed footholds. The inclusion of footholds on a given container allows user/s to stabilize container when adding of removing contents. Keeping a container steady while adding or removing contents (liquids, grains, waste, large objects, or beings), by one or more individual.

Examples include but not limited to: removing a slippery baby from a portable baby tub without spilling bathwater or tipping tub. Washing a pet, farm animal etc. in a portable tub while holding tub in place. Removing a tight fitting metal garbage lid using both hands, without the need to straddle the bin. Removing with one hand, any tightly sealed potash lid or compost lid while holding contents to add to container in other hand.

Removing a heavy bag of trash using both hands. Opening a paint bucket with a tight fitting lid or seal lid like found on large 5-gallon drywall buckets. Which is extremely difficult to do without a second person holding the bucket down while first person lifts.

By stepping into the foothold, operators' hands are freed up pour, place, insert, drop contents into a container or to extract contents from a container, while keeping container in place. Additionally, location of footholds makes container stackable thereby allowing for more efficient use of consumer, store, and factory shelves, as opposed to exterior footholds like rings or add-ons to the container.

A container with such footholds can allow for container bag extraction. Footholds also allow for tight fitting container lids to be removed, by having one or two hands free, without straddling the container, to hold it in place or risking contents to spill out during operation. Picture carrying a smelly, leaking bag of garbage to the trash bin only to have to put the bag down and wrestle the lid off the bin. This eliminates the step of putting the bag down, since one foot goes onto the foothold, while the free hand lifts the lid and bin. Sometimes one may need to fill a container with large items that need balancing until the container is ready to be carried off, such a tree branch debris being able to stabilize the container is of great benefit.

Additionally, such footholds would ease lifting out a slippery baby, pets, wildlife, farm animals from a plastic bathtub. Caretakers lifting out an invalid from a freestanding bathtub, or pets from a grooming tub also find benefit, and thrashing grabbing and wiggling can move bin.

As mentioned prior, a concave foothold also allows for stacking in warehouses of the containers, allowing multiple containers to be stored on shelves awaiting use or purchase.

Ideal applications would include tall narrow containers, garbage bins, baby bathtubs, pet tubs, troughs, trash cans, ash containers, recycle and compost containers, medical receptacles, and containers with tight fitting lids, each requiring stack ability in warehouses or store shelves.

Upon review of various patents in the container and tub industry, there are several designs shapes and sizes but non that exclusively promotes the foothold and a safety or operational factor in ease of use, and allow for stacking application. The process of adding or extracting contents from a container can result in tipping of said container, which makes footholds beneficial additions to most all portable containers.

### Cross Reference to Related Applications

There are several versions of footholds in containers, primarily in design patents. But in terms of utility it seems they are primarily for trash receptacles. For example, U.S. Pat. No. 7,438,199 names “Vacuum Release Trash Container Apparatus” by Andrew P. Tidrick (2008) Noting claim 1, pg. 8 “A vacuum release trash container apparatus for use with trash container bags” which comprises various inclusions to allow one to remove a bag. But these combination of features, would be too costly to produce or difficult to maintain from a sanitary perspective. Tidrick presents in the drawing foothold incorporating the orifices (on interior side wall) of the double walled trash container, my foothold do not require orifice connections. His would present a problem with leakage of bag contents especially liquid into the orifices. His orifices also allow for insects and rodents to find their way in to the double sidewalls, and provides sets up an environment for rust accumulation, rot, and unsanitary conditions. Therefore, the simplicity of my invention, simple footholds in containers creates more universal adoption and sanitary use while reducing costs to both customer and manufacturer.

U.S. Pat. No. 9,682,818 has a suction cup system to hold down the container, which would require a smooth surface not guaranteed with many portable containers.

U.S. Pat. No. 8,955,710 appears to have a tie down system.

U.S. Pat. No. 8,844,751 has an extruded foothold encompassing entire bin which doesn't allow for stacking. There appears to be no troughs, buckets or bathing tubs, compost containers or potash containers that contain footholds as described.

This improved and simplified application of footholds allows many manufacturers to improve their container products. The concept is simple but far reaching in its uses.

### DETAILED DESCRIPTION OF THE INVENTION

Depending on the size of the container a minimum of one concave foot hold (1) can be applied adjacent to floor (2) and sidewall (3), but not to extrude beyond container wall (3). Concave footholds allow for stacking of containers, bins or tubs in warehouse or store shelf. Ideally the product is a single molded item to avoid seams and potential leakage, or it is welded or bonded by some chemical bonding compound. Or a mesh container would likely contain a orifice foothold (1) the shape of the concave foothold can be left up to the factory's manufacturing capabilities, but when possible allow an adult male foot to slip in beyond the toes but before the arch of the foot. This may not be possible on smaller containers.

Drawings on Page 1 shows samples of concave footholds on sloped (FIGS. 1a and 1b) or non-slopped containers (FIGS. 2 thru 5), in the later case top view only is shown.

These drawing set represents various container shapes and sizes, with only FIGS. 1a and 1b representing a sloped non base container, front and top view, respectively. Drawings on page 1 shows the concave foothold (1) without a base below the floor (2) of the container. Footholds (1) must be large enough to allow use to hold down the container adequately. And footholds (1) must be adjacent to floor (2) below and within the wall (3) of the container.

If concave foothold (1) is not molded into and above the floor (2) of the container (as in FIG. 1a FIG. 1b—Drawing Page 1), an alternate orifice foothold can be cut into the base (4) of a container (FIG. 6a and FIG. 6b Drawing Page 2) below the floor (2) of the container.

These footholds (1) can be placed in any metal, plastic, fiberglass, composite material, or plant material or any various “other” material (currently unknown to inventor) that is lightweight or portable and is a container at risk of tumbling when adding contents or removing contents. By

installing the footholds (1) in pairs ideally shoulder width apart (but not limited to), one can easily hold down the container while pouring grains or liquid, or tossing objects or placing persons or animals within.

If two people are working together, each can step on a single foothold (1) on opposite sides of the container to avoid flipping when extracting an object as seen in all Figures.

1. Recessed concave foothold/s within the wall plane of the portable (solid or meshed) container, as in, but not limited to buckets, troughs, trash cans, bins, or buckets, molded into the floor of the container, directly above the floor.

2. A minimum of two concave or orifice footholds, within the wall, above or below the floor, spaced approximately shoulder width apart of a portable container, which can receive a minimum of the first third of various human foot widths and heights, able to receive two feet of one person, or if place on opposite sides of a portable container can individually receive one or more feet of several people. Said footholds should be able to receive transfer of weights of those employing the use of the footholds.

3. An orifice foothold in the same wall plane directly below the floor of the portable container spaces as in Claim 2, but found directly below a containers raised floor, or in a mesh container above or below the floor, of the same width and height, at same described location in claim 2 for the same purposes as claim 2.
